(19) United States
(12) Patent Application Publication
(10) Pub. No.: US 2002/0078140 A1
(43) Pub. Date: Jun. 20, 2002

(54) Remote web page maintenance

(76) Inventors: Ciaran Kelly, Murrough (IE); Kevin Farrell, Barna (IE); William O'Reilly, Galway (IE)

Correspondence Address: Lee, Mann, Smith, McWilliams, Sweeney & Ohlson, PO Box 2786, Chicago, IL, 60690-2786, US

(21) Appl. No.: 09/741,260

(22) Filed: Dec. 19, 2000

(51) Int. Cl. G06F 15/16; G06F 17/00

(52) U.S. Cl. 709/203; 707/513

(57) ABSTRACT

A method of maintaining a website by parsing a source file to locate editable fields delimited by “edit” tags. The contents of these fields are presented to a user, who is generally remote from the web server hosting the page. The user updates the field contents and the program generates a new source file including the edited contents which overwrites the original file.

### FIELD OF THE INVENTION

The present invention relates to web page and web site maintenance.

### BACKGROUND OF THE INVENTION

Web sites are collections of web pages forming part of the world wide web maintained on the Internet or maintained e.g. on a company intranet. Most web pages are written in hypertext mark-up language (HTML) and can include text, pictures, video and other media, and links to other web pages. Each of these content types may need to be edited over time to update the site itself or to take account of changes in other sites (e.g. new addresses for linked pages or changed locations of picture files).

Many individuals and organisations employ a skilled writer to write the HTML pages of their websites. The party (site owner) commissioning the author of the pages will normally have an input into the content of the site at the time of writing the pages, but will be unable to subsequently edit the pages without skilled help. In the event that the owner wishes to make changes in content at a later date, the author or someone else skilled in HTML, will have to be re-commissioned to make the desired changes. If this expense or effort is not considered justified, this can result in the desired changes not being made. Many sites are therefore static over long periods of time, reflecting outdated information such as price lists, personnel and contact details, and product inventories.

While a number of web page authoring applications exist to assist in creating web pages and changing their content, most are either too complex for unskilled users, or so simple that the pages created will not match the quality of a professionally produced page.

The invention has as an object the provision of a method and computer program for use in web site maintenance which allows unskilled users to easily, and optionally remotely, update web pages.

### SUMMARY OF THE INVENTION

In a first aspect the invention provides a method of updating an original web page source file, the method involving the following steps:

parsing or analysing the original source file to identify an editable field;

presenting the contents of this field to a user in an editable format;

receiving as an input the edited contents of the field; and

generating an edited source file which has been updated by the inclusion of the edited contents.

As the skilled person will be aware, web pages are stored as files on web servers in, for example, HTML format. Such files specify, inter alia, the colour and pattern of the background to the page, the font, format and colour of each section of text, the location on the web server (or another server) where picture files, video clips or sound files can be found, and for Internet links, both the text of the link to be seen by the user (e.g. “Back to homepage”) and the destination as an address (e.g. c:webpageshomepage.htm).

If a site owner has an interest in updating any of these fields, then when the page is originally written the author can identify each such field as being editable. The invention then enables one to extract the fields so identified, present the field contents to the user for editing, and when they have been edited, reinsert them in the source file to generate an updated page.

The user needs to have no skill in HTML, and the page can be as sophisticated or content-laden as the original author wishes. Once the basic layout and content of the page have been chosen, the content can be updated without further reference to the author, as often as the site owner wishes.

The method preferably also includes the step of saving the edited source file in place of the original source file.

The parsing of the original source file can be effected by identifying an editable field by means of a tag associated with the field. Thus, some fields could be fixed, and some fields tagged as editable.

Preferably, the field is delimited by a pair of tags at the beginning and end, respectively, of the editable field contents.

The original and edited source files may be written in hypertext mark-up language (HTML), as explained below, or in another mark-up language such as Extensible Mark-up Language (XML), Extensible Hypertext Mark-up Language (XHTML) or Standard Generalized Mark-up Language (SGML).

The field contents can include a string of text, or a hypertext linlk, or a media object such as a picture file, a sound file, a video clip, or an animation.

Preferably, the parsing of the original source involves identifying a plurality of editable fields, if present in the page.

In preferred embodiments, the contents of each editable field are presented to a user for editing. For example, when a user executes the method of the invention by running a program (by means of a menu instruction, a browser button, or even a link on the page itself), the program can run through the HTML file, picking out the contents of each editable field. It may then generate a display having an area containing the field contents of each editable field as editable text.

In these areas, the nature of the field might be identified for the benefit of the user (e.g. each area could be designated as containing text, or a picture file, or a hypertext link).

More preferably, the page presented to the user will have the general appearance of the original page, but with the editable field contents in an editable box.

Preferably, when the original source file is parsed, the contents of the source file, other than the editable field contents themselves, are temporarily stored with an identification of the location of the editable field, for use in the subsequent generation of the updated source file.

The contents of the field can be pre-edited before being presented to the user. In particular, the pre-editing of the contents can result in only a portion of the field contents being presented to the user.

For example, while it might be desirable to present the entirety of a section of text to a user for editing, the same might not be true of a field defining the location of an image file. If this field were to read <img src=“image1.gif”>, then the program could present only the text “imagel.gif” to allow an inexperienced user to easily identify what should be changed.

In a preferred embodiment, the method of the invention is executed on a server on instructions received from a remote client.

The method may also include the step of authenticating the user before parsing the file. This can be done by presenting, as a first step, a login box in which the user must enter a username and password. This is particularly important where the program allows remote access to edit the contents of a web page, to ensure that the page is not edited by an unauthorised person.

The method may also include the step of conducting a check on the edited contents of the field prior to generating the edited source file.

This check can be, in the case of a text field, a spellchecking subroutine or a word or character counting subroutine.

In the case of a field identifying a media file location, the check can be a verification of the presence of the file at the location.

In the case of a hypertext link, the check can be a verification of the validity of the linked destination.

If the results of the check indicate that the data appear to be invalid, for whatever reason, the user can be prompted to re-edit the data before the edited web page source file is generated.

In another aspect, the invention provides a web page including at least one editable field, where this field is delimited by a pair of tags at the beginning and end, the tags identifying the field as being editable.

The web page is preferably written in a mark-up language, most preferably HTML, XML, XHTML or SGML.

As will be described further below, the tags can be embedded within or otherwise associated with a further pair of tags identifying to a browser the nature of the field contents. For example, a paragraph of text in a HTML-based web page is identified at the beginning by the tag <P> followed by the text itself, and at the end of the text, the tag </P> marks the paragraph end. Other tags are commonly inserted between these paragraph delimiters, such as a tag specifying that the paragraph is in italic text (e.g. <P><I> . . . </I></P>). According to the invention, a pair of tags specifying the beginning and end of an editable field (e.g. <EDIT> . . . </EDIT>) could equally be inserted in the manner of the italic identifier.

In a further aspect the invention provides a computer program which causes a computing device to:

analyse or parse an original web page source file to identify an editable field;

present the contents of this field to a user in an editable format;

receive as an input the edited contents of the field; and

generate an edited source file which has been updated by the inclusion of the edited contents.

The computer program of the invention can be embodied in a web browser for use on a client computer, allowing the browser to retrieve the original source file from a remote server, and to send the edited source file to the server to be saved thereon.

The invention provides, in another aspect, a computer system on which the computer program of the invention is loaded.

The computer system can be a client device remotely connected via a communications network to a web server on which the original source file is stored.

The invention also provides a web server running the program of the invention and storing at least one original source file accessible by the program.

The invention further provides a communications network including the above web server.

### BRIEF DESCRIPTION OF DRAWINGS

The invention will now be illustrated by the following descriptions of embodiments thereof given by way of example only with reference to the accompanying drawings, in which:

FIG. 1 is an overview of a system architecture in which the invention is implemented;

FIG. 2 is a view of a web page according to the invention;

FIG. 3 is the HTML source code of the web page of FIG. 2;

FIG. 4 is a flow chart illustrating a method of the invention;

FIG. 5 is a view of a web page generated in the method of the present invention to enable a user to edit the page of FIG. 2;

FIG. 6 is a view of the web page of FIG. 5, after changes have been made by the user;

FIG. 7 is a view of the web page of FIG. 2 incorporating the changes made in FIG. 6

FIG. 8 is the HTML source code of the web page of FIG. 7;

FIG. 9 is a flow chart illustrating the method of the invention in greater detail;

FIG. 10 is a table showing temporary strings into which the file of FIG. 3 is parsed according to the invention; and

FIG. 11 is a table showing the temporary strings of FIG. 10 after the changes made in FIG. 6 are taken into account.

### DETAILED DESCRIPTION OF PREFERRED EMBODIMENTS

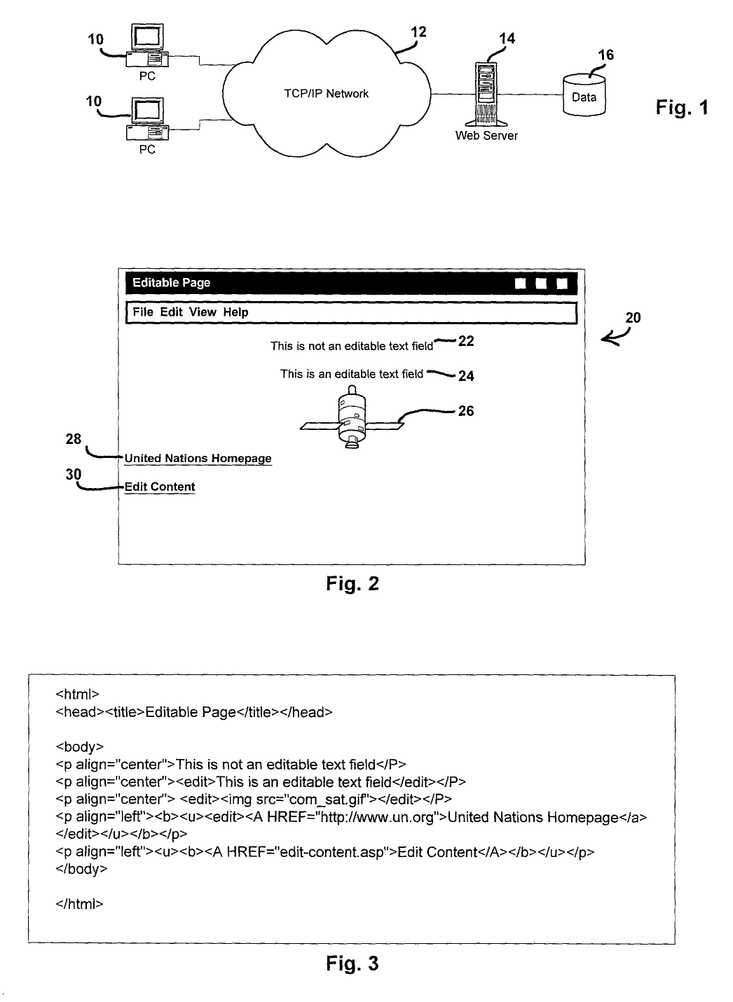

In FIG. 1 there is shown a network architecture in which a number of PC users 10 are connected via a network 12 (e.g. the Internet or a local area network or LAN) to a web server 14. The web server stores a set of web pages in a database 16 and transmits the pages to the PCs as and when they are requested. The server also hosts a web page editing application which users can access with a suitable password and username combination.

FIG. 2 shows a very simple web page 20 which users can access from the database 16 hosted by the web server. The web page comprises two lines of text 22, 24, a picture 26, and two links 28, 30.

FIG. 3 shows the HTML source code used to generate the web page of FIG. 2. It can be seen that the code for the page defines only a few elements:

a) the title bar header (“Editable Page”),

b) a first paragraph (“This is not an editable text field”),

c) a second paragraph (“This is an editable text field”),

d) a picture file (comrsat.gif, which is an image of a communications satellite located in the same directory as the web page itself),

e) a link to the website of the United Nations, containing both the web address and the display text “United Nations Homepage”, and

f) a link entitled “Edit Content”, which leads to an active server pages (ASP) file, edit-content.asp, which is also located in the same directory (it will be appreciated that both the application and the image file could equally be located in another directory or on a different machine). The edit-content.asp page is thus launched if a user clicks on the “Edit Content” link in the page of FIG. 2.

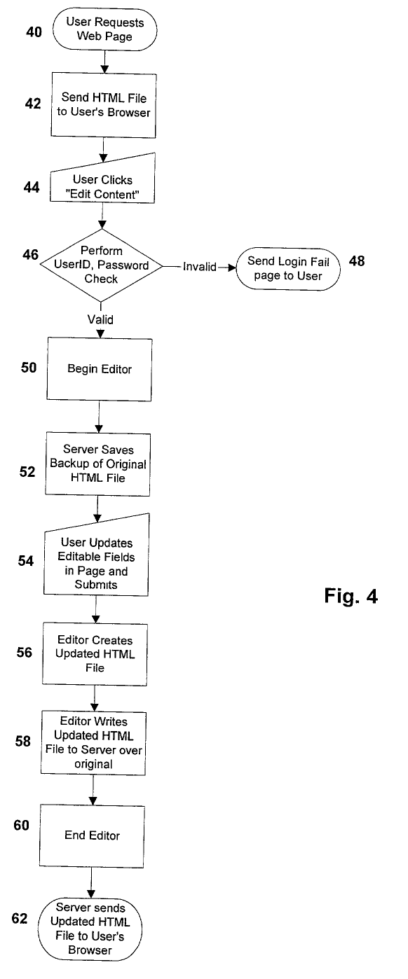

FIG. 4 shows a flowchart of the overall process followed when a user opens and edits a web page in accordance with the invention. The user accesses the web server by typing in the Internet address of the web page in the normal way, step 40, causing the web server to retrieve the HTML file of the requested page and send this to the user using the HTTP protocol over the Internet, step 42. The user's browser receives the HTML file of FIG. 3 and generates a web page as in FIG. 2.

The user clicks the “Edit Content” link, step 44, causing the server to launch the edit-content.asp page. This contains visual basic scripting which is run by the web server to dynamically generate a web page, and can be thought of as equivalent to a web page authoring application. It will be described in terms of an application below, and it is to be understood that the invention is by no means limited to an ASP implementation, or indeed implementation by any specific application.

The first task carried out by the application is a login process, step 46, to ensure that the user is entitled to edit the page content. If the user cannot enter a valid identification and password, then the application returns a login fail result to the server and the server sends the user a page indicating that the login has failed, step 48. If the user can log in successfully, the application continues by running the editor routine, step 50.

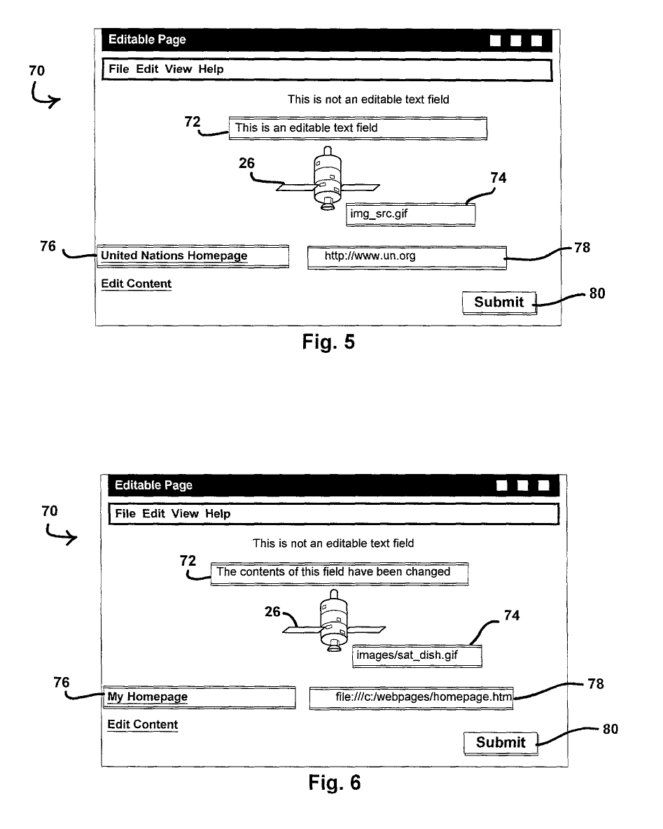

When the editor begins, the server first saves a back-up copy of the page to be edited, step 52, to allow the site owner to later restore the original version of the page, should this be required. The editor then locates all editable fields in the HTML file of the page being edited, as will be described more fully below, and generates a web page or an editable form having an editable text box for each editable field, with the contents of the field in the text box. The page 70 generated in this part of the process is shown in FIG. 5.

It can be seen that the page has a similar appearance to the original page of FIG. 2, but with a number of editable text boxes. The generation of such a page is well known in the art of writing web pages, and is effected by substituting, for the original fields tagged as being editable, a text box which can be edited by the user and then submitted by pressing a submit button.

The first editable text field 72 includes the text of line 24 (FIG. 2). The second text box 74, adjacent the image 26, includes the file location of the image. The third box 76 and fourth box 78 contain the display text for the link 28 and the destination address to which the user is directed when the link is clicked. Finally, a “Submit” button 80 is included for the user to submit changes.

FIG. 6 shows the same page 70 after the user has made some changes in each field, i.e. (i) the text field 72 now reads “The contents of this field have been changed”, (ii) the image field 74 now refers to a file named satdish.gif in a sub directory (“images”) of the current directory, and (iii) the link 76,78 has been updated to point to a homepage called “My Homepage” on the same machine as the page being edited.

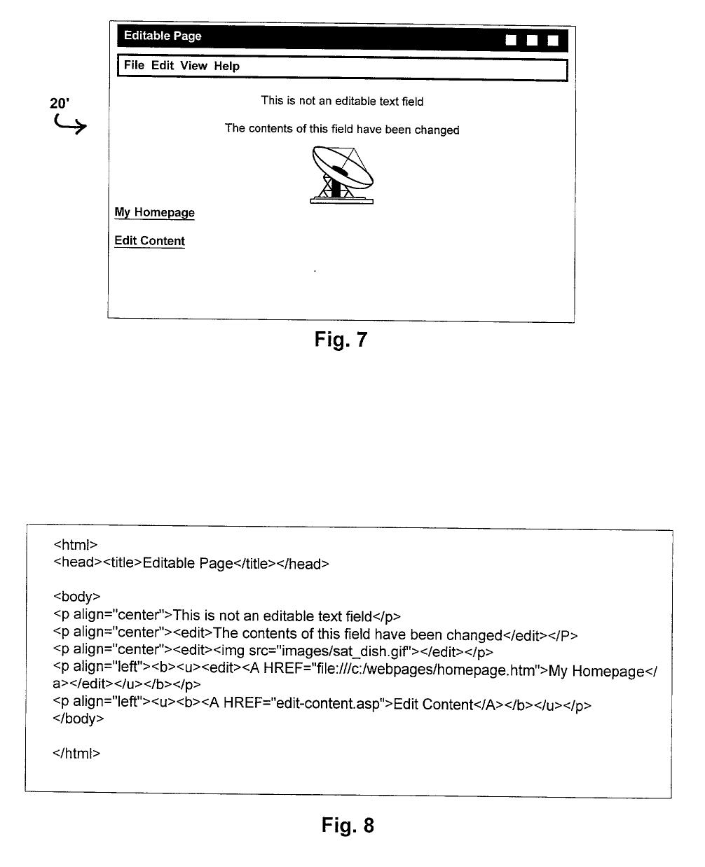

The user clicks the “Submit” button 80 when the changes have been made causing the user's browser to send the form back to the server with the new information, step 54 (FIG. 4). The editor extracts this information from the form and creates a new HTML file, step 56, as described below, which is saved in the database overwriting the original source file, step 58, before the editor terminates, step 60. The web server sends the new HTML file to the user, step 62, and this file is then displayed on the user's PC as the web page 20′ of FIG. 7. FIG. 8 shows the corresponding HTML file which can be seen to be identical to that of FIG. 3 apart from the replacement of the edited field contents.

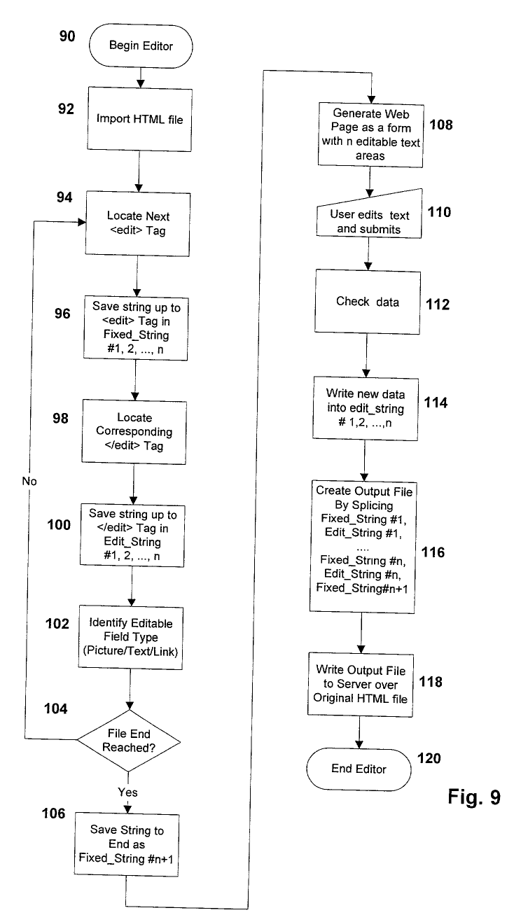

FIG. 9 is a more detailed flowchart of the operation of the editor routine. When the application has verified the user ID and begins the editor routine, step 90, the editor first retrieves the HTML code from the database, step 92. The editor then begins to parse this file looking for the text string “<edit>”, step 94. The string of text from the beginning of the file up to and including, “<edit>” is then saved as fixed_string_{—}1 in memory, step 96.

The editor then continues to phrase the file looking for the tag “</edit>”, step 98, and saves the text up to but not including this tag as edit_string_{—}1 in memory, step 100. The content of edit_string_{—}1 is then analysed to determine the type of content, step 102, which in this simple example is either an image file (identifiable by the characters “<img src=”), a hypertext link (identifiable by the characters “<A HREF=”), or is otherwise assumed in all other cases to be simple text.

The application could of course be aware of other content types, each identifiable by the relevant HTML tag. A label is stored with the string identifying it as an image, link, or text field. Unless the end of the file has been reached, step 104, the process reverts to step 94 to further parse the file from the located “End Edit” tag (</edit>) to the next “Begin Edit” tag (<edit>), storing this string as fixed_string_{—}2, and repeating the process to store the following editible field as edit_string_{—}2. This iteration repeats n times until the file end is detected, following which the last section of the file is stored as fixed_string_n+1, step 106, to give a total of 2n+1 strings which when spliced together provide the original source file, where n represents the number of editable fields in the file.

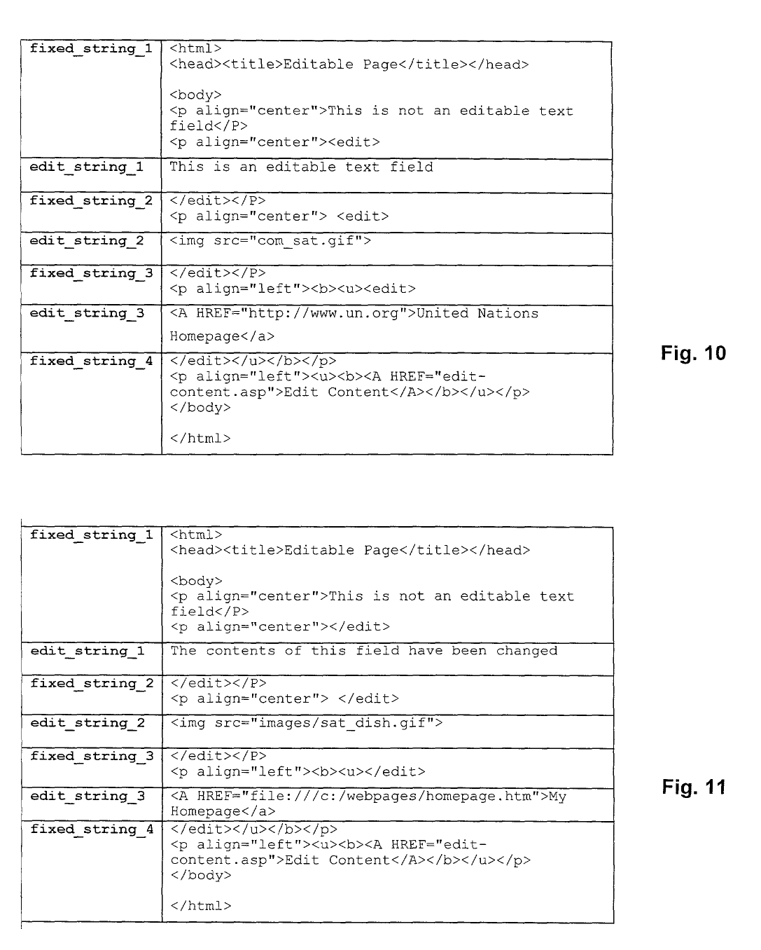

FIG. 10 shows the resulting 7 strings generated in the case of the HTML file of FIG. 3. The application then generates a web page, step 108, as a form such as is shown in FIG. 5, having n areas for the n editable fields, and formats each area depending on the identity of the field. Thus for the text fields (see FIG. 5) a text box is provided into which the whole of the relevant edit_string is pasted. For image fields, that part of the edit_string following “<img src=” and before the closing angled bracket is pasted into a text box. For link fields, two text boxes are provided, one for the link destination, and one for the display text, both of which can be easily identified from the structured format of the edit_string.

The editor then outputs this form to the user as a web page and awaits a response by the user pressing a submit button embedded in the page. The user does this after the text in one or more of the boxes has been edited to his or her satisfaction, step 110.

The editor receives back the form containing the user-edited data, and conducts a check on the integrity of the data for the given field type, step 112. This may involve, in the case of local file locations, checking that the file is in the location specified. For web addresses, it may involve accessing the site to ensure the address exists. For text entries, it may involve a spell check or a word or character count to ensure that the length of the text will not cause formatting problems in the resultant page.

A word or character count limit (either upper or lower) can be set within the original HTML file itself by defining new tags (e.g. <greaterthan=“30”><lessthan=“120”>) setting these limits. The advantage of using tags such as these (and indeed the “Begin Edit” and “End Edit” tags), is that they are simply ignored by the browser unless the browser is set up to derive information from them. Thus, their inclusion in the page allows the editing application to operate but does not interfere with the viewability of the page by conventional browsers.

The data, assuming that the various checks are passed, are then written into the edit_strings to replace the data originally presented to the user, step 114. Thus, for example, text field edit_strings are simply overwritten, image file locations are pasted into the relevant editstring between quotation marks in place of the original file location, and hypertext links and the associated text are similarly written over the corresponding original sections of the relevant edit_string.

In the case of the changes made by the user in FIG. 6, the resulting sets of strings after amendment by the editor are shown in FIG. 11. The editor then generates a new HTML file by splicing together the strings one after another, step 116, and saves this HTML file, step 118, in place of the original file (which has already been saved in a back-up location). The editor process then terminates, step 120.

In an alternative arrangement, the editor functions can be provided as part of a web browser. When the browser loads a web page it automatically checks for a pair of <edit> . . . </edit> tags, and if present, a toolbar button or menu option to edit the page is activated (this option otherwise being inactive or “greyed out”). If a user clicks the button, the browser parses the page in the same manner as described above and generates the form for the user on the user's own machine. Changes made by the user are saved in a new HTML file which is then sent by the browser to the web server, with instructions for the web server to back up the original HTML file and replace it with the newly generated file (which will presumably only occur if the user has the necessary authority, verifiable by a confirmation password screen, a digital certificate accompanying the HTML file, or some secure encryption method based on a user's key).

The invention is not limited to the embodiments described herein which may be varied without departing from the spirit of the invention.

What is claimed is:

1. A method of updating an original web page source file, comprising the steps of:
a) parsing the original source file to identify an editable field;
b) presenting the contents of said field to a user in an editable format;
c) receiving as an input the edited contents of said field; and
d) generating an edited source file in which said field has been updated by the inclusion of said edited contents.

2. A method as claimed in claim 1, further comprising the step of saving said edited source file in place of the original source file.

3. A method as claimed in claim 1, wherein said parsing of said original source file is effected by identifying an editable field by means of a tag associated with said field.

4. A method as claimed in claim 3, wherein said field is delimited by a pair of tags at the beginning and end, respectively, thereof.

5. A method as claimed in claim 4, wherein said original and edited source files are written in a mark-up language.

6. A method as claimed in claim 5, wherein said mark-up language is selected from Hypertext Mark-up Language (HTML), Extensible Mark-up Language (XML), Extensible Hypertext Mark-up Language (XHTML) and Standard Generalized Mark-up Language (SGML).

7. A method as claimed in claim 1, wherein said field contents comprise a string of text.

8. A method as claimed in claim 1, wherein said field contents comprise a hypertext link.

9. A method as claimed in claim 1, wherein said field contents comprise a media object location.

10. A method as claimed in claim 9, wherein said media object is selected from a picture file, a sound file, a video clip, and an animation.

11. A method as claimed in claim 1, wherein said parsing of said original source file comprises identifying a plurality of editable fields, if present in said page.

12. A method as claimed in claim 11, wherein step (b) comprises presenting the contents of each editable field to a user for editing.

13. A method as claimed in claim 1, wherein step (b) comprises generating a display having an area in which the field contents are included as editable text.

14. A method as claimed in claim 1, wherein when said original source file is parsed, the contents of the source file other than the editable field contents are temporarily stored with an identification of the location of the editable field, for use in the subsequent generation of the updated source file.

15. A method as claimed in claim 1, wherein the contents of said field are pre-edited before being presented to said user.

16. A method as claimed in claim 15, wherein the pre-editing of said contents is effective to cause only a portion of the field contents to be presented to the user.

17. A method as claimed in claim 1, when executed on a server on instructions received from a remote client.

18. A method as claimed in claim 1, further comprising the initial step of authenticating said user before parsing said file.

19. A method as claimed in claim 1, further comprising the step of conducting a check on the edited contents of the field prior to generating the edited source file.

20. A method as claimed in claim 19, wherein said check comprises, in the case of a text field, a spellchecking subroutine.

21. A method as claimed in claim 19, wherein said check comprises, in the case of a text field, a word or character counting subroutine.

22. A method as claimed in claim 19, wherein said check comprises, in the case of a field identifying a media file location, a verification of the presence of the file at the location.

23. A method as claimed in claim 19, wherein said check comprises, in the case of a hypertext link, a verification of the validity of the linked destination.

24. A web page comprising at least one editable field, wherein said field is delimited by a pair of tags at the beginning and end of said field, said tags identifying the field as being editable.

25. A web page as claimed in claim 24, when written in a mark-up language.

26. A web page as claimed in claim 25, wherein said mark-up language is selected from Hypertext Mark-up Language (HTML), Extensible Mark-up Language (XML), Extensible Hypertext Mark-up Language (XHTML) and Standard Generalized Mark-up Language (SGML).

27. A web page as claimed in claim 26, wherein said field is further delimited by a further set of tags effective to identify to a browser the nature of the field contents.

28. A computer program product in machine readable form containing instructions which when executed cause a computing device to:
a) parse an original web page source file to identify an editable field;
b) present the contents of said field to a user in an editable format;
c) receive as an input updated contents of said field after editing by said user; and
d) generate an edited source file in which said field has been updated by the inclusion of said edited contents.

29. A web browser for use on a client computer, comprising a computer program as claimed in claim 28, wherein said instructions are further effective to retrieve said original source file from a remote server, and to send said edited source file to said server.

30. A computer system comprising a computer program as claimed in claim 28.

31. A computer system as claimed in claim 30, wherein said system is a client device remotely connected via a communications network to a web server on which said original source file is stored.

32. A web server comprising a computer program as claimed in claim 28 and at least one original source file accessible by said program.

33. A communications network comprising a web server as claimed in claim 32.
